(19) United States
(12) Patent Application Publication
(10) Pub. No.: US 2007/0255580 A1
(43) Pub. Date: Nov. 1, 2007

(54) Lending System and Method

(75) Inventors: Stephen James Cole, Nedlands (AU); Kari Jeanne Paulson, St Kilda (AU)

Correspondence Address: GARDNER GROFF GREENWALD & VILLANUEVA. PC, 2018 POWERS FERRY ROAD, SUITE 800, ATLANTA, GA, 30339, US

(73) Assignee: EBOOKS CORPORATION LIMITED, Claremont, AU (AU)

(21) Appl. No.: 11/571,186

(22) PCT Filed: Jun. 22, 2005
(86) PCT No.: PCT/AU05/00900

§ 371 Date: Dec. 22, 2006

(30) Foreign Application Priority Data
Jun. 22, 2004 (AU) 2004/903334

(51) Int. Cl. G06Q 30/00

(52) U.S. Cl. 705/1

(57) ABSTRACT

A lending system for lending an econtent item comprises a library server having a processor and a number of databases. Borrowers can access the system using a PDA or other suitable communications device over a communications network. Each econtent item has a number of loan instances allocated to it, and the econtent item can be made available to borrowers up to a maximum number of predetermined loan instances over a set period of time. A single loan instances can be typically defined as a period of between 5 minutes and 24 hours to a single borrower, with an econtent item having an allocation of a set number of loan instances per calendar year, for example, 325 loan instances. This allows the econtent item to be made available to multiple concurrent users or single users as long as the number of loan instances has not been exceeded in any given year.

### FIELD OF THE INVENTION

The present invention relates to a lending system and method for lending an electronic item.

The present invention has particular utility in lending an electronic content (“econtent”) item such as an electronic book (“ebook”). However, the invention is also applicable in lending other electronic items, such as software.

Throughout the specification, unless the context requires otherwise, the terms “econtent” and “econtent item”, will be understood to refer to any published material stored, distributed and/or accessed in digital form. Econtent items include, but are not limited to, books, journals, monographs, articles, chapters, documents, diaries, images, movies, and music stored, distributed and/or accessed in digital form.

Furthermore, throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background to the invention is intended to facilitate an understanding of the present invention. However, it should be appreciated that the discussion is not an acknowledgement or admission that any of the material referred to was published, known or part of the common general knowledge of the person skilled in the art in any jurisdiction as at the priority date of the application.

Systems and methods have been disclosed enabling the distribution of econtent items via a communications network, such as the Internet. One such system and method is known as Library Econtent Distribution.

In Library Econtent Distribution, a customer organisation enters into an agreement with an econtent aggregator or publisher to make econtent items available to members of the organisation via the communications network. By virtue of the agreement, members of the organisation are able to access and download econtent items via the communications network to a communications device, such as a personal computer or a Personal Digital Assistant, without paying a fee for doing so.

Library Econtent Distribution is effected in either of two ways:
a) “Multiple Concurrent Use”; or
b) “One User at a Time”.

“Multiple Concurrent Use” allows the customer organisation to make econtent items simultaneously available to multiple members. However, it requires the customer organisation to take out a subscription to a collection or database of econtent from the econtent aggregator or publisher. This is unsatisfactory for some customer organisations in that the collection that the customer organisation has to subscribe to typically has many econtent items that it does not want. Additionally, if the customer organisation stops paying the subscription fee, it loses access to the collection.

Under “One User at a Time”, the customer organisation buys individual econtent items from the econtent aggregator or publisher. This allows the customer organisation to select its own collection of econtent. Additionally, the customer organisation only has to pay once up-front for each econtent item. There are typically no annual subscription fees, although there may be a small annual maintenance fee to cover bandwidth and maintenance for the communications network. However, as its name implies, there is a problem in that the customer organisation is limited to making each econtent item available to only one member at a time. The result is that sometimes, when two or more members try to access the same item simultaneously, one or more members are turned away.

Both “Multiple Concurrent Use” and “One User at a Time” systems have specific deficiencies which mean that users are unreasonably constrained, or customer organisations face cost uncertainties and inefficiencies. The customer organisations are faced with a dilemma:
1. Choose a method whose costs are easy to control, but that fails to allow for peaks and troughs in demand for specific econtent items (“One User at a Time”); or
2. Choose a method that allows for multiple concurrent use of econtent items but whose future costs are uncertain, and whose collection of econtent items may be of only marginal or patchy relevance.

The present invention seeks to provide a system and method for lending an electronic item that alleviates some or all of the above problems to some extent.

### DISCLOSURE OF THE INVENTION

In accordance with a first aspect of the invention there is provided a lending system for lending an electronic item from a host server to a client, the electronic item permitted to be lent for a predetermined total loan period; the lending system comprising:
a host server to which a client may be selectively connected via a communications network to convey messages there-between;
the host server having storage means for storing the electronic item;
the host server having loan managing means for recording the period the electronic item has already been loaned; and
the host server having processing means to process messages received via the communications network;
   wherein upon receipt of a request message from the client via the communications network, where the request message comprises an identifier for the electronic item and a requested loan period, the processing means is operable to: determine a cumulative loan period comprising the total of the requested loan period and the period that the electronic item has already been loaned; to compare the cumulative loan period with the total loan period; and, if the cumulative loan period does not exceed the predetermined total loan period, to make the electronic item available to the client for the requested loan period.

This has the advantage that the electronic item—which may be an electronic book or other publication—can be provided to more than one person simultaneously, or a number of people at different times, only providing that this total loan period is not exceeded. This provides the extra flexibility not available through the known systems.

Preferably, if the cumulative loan period exceeds the total loan period, the processing means is operable to make the electronic item available to the client for a period equal to the requested loan period minus the period that the cumulative loan period exceeds the total loan period.

Preferably, the total loan period is valid for a predetermined length of time, which may be one year.

Preferably, as it is desirable to lend these electronic items to members of the system, the client may have a unique identifier to uniquely identify the client to the host server, and the request message further comprises the unique identifier and the processing means further processes the unique identifier to authenticate the identity of the client.

Preferably, the system will also comprise a digital rights manager for controlling the extent to which the electronic item is protected.

Each loan period may comprise a predetermined number of loan instances, each loan instance being any period greater than five minutes and less than 24 hours.

In another aspect of the present invention, there is provided a lending method for lending an electronic item from a host server to a client, the electronic item permitted to be lent for a predetermined total loan period; the lending method comprising:
recording the period the electronic item has already been lent;
receiving a request message from the client via a communications network, the request message comprising an identifier for the electronic item and a requested loan period;
determining a cumulative loan period comprising the total of the requested loan period and the period the electronic item has already been lent; and
if the cumulative loan period does not exceed the predetermined total loan period, making the electronic item available to the client for the requested loan period.

Preferably, if the cumulative loan period exceeds the total loan period, the electronic item is made available to the client for a period equal to the requested loan period minus the period that the cumulative loan period exceeds the total loan period.

Preferably, the total loan period is valid for a predetermined length of time, which may be one year.

Preferably, the method may include further steps of:
allocating a unique identifier to uniquely identify the client to the host server, and the request message further comprises the unique identifier; and
authenticating the identity of the client using the unique identifier.

The method may also include the step of controlling the extent to which the electronic item is protected.

Preferably, each loan period comprises a predetermined number of loan instances, where each loan instance is any period greater than five minutes and less than 24 hours.

In a further aspect of the invention, there is provided a host server for use in a lending system for lending an electronic item, the electronic item permitted to be lent for a predetermined total loan period, the host server being arranged to be selectively coupled to a client via a communications network to convey messages there-between, the host server comprising:
storage means for storing the electronic item;
loan managing means for recording the period the electronic item has already been loaned; and
processing means operable to process messages received via the communications network;
   wherein upon receipt of a request message from the client via the communications network, where the request message comprises an identifier for the electronic item and a requested loan period, the processing means is further operable to: determine a cumulative loan period comprising the total of the requested loan period and the period that the electronic item has already been loaned; to compare the cumulative loan period with the total loan period, and, if the cumulative loan period does not exceed the predetermined total loan period; make the electronic item available to the client for the requested loan period.

Preferably, the processor is operable, if the cumulative loan period exceeds the total loan period, to make the electronic item available to the client for a period equal to the requested loan period minus the period that the cumulative loan period exceeds the total loan period.

Preferably, the total loan period is valid for a predetermined length of time, which may be one year.

The client may have a unique identifier to uniquely identify the client to the host server, and the request message may further comprise the unique identifier and the processing means is further operable to process the unique identifier to authenticate the identity of the client.

Preferably, the host server further comprises a digital rights manager for controlling the extent to which the electronic item is protected.

Preferably, each loan period comprises a predetermined number of loan instances, where the loan instance may be any period greater than five minutes and less than 24 hours.

### BRIEF DESCRIPTION OF THE DRAWINGS

The present invention will now be described, by way of example, with reference to the accompanying drawings, of which;

FIG. 1 is a schematic illustration of an embodiment of a system and method for lending an electronic item in accordance with an aspect of the present invention;

FIG. 2 is a calendar showing lending of an electronic item by the system and method of FIG. 1;

FIGS. 3A-3E are flow charts showing operation of a loan manager of the system and method of FIG. 1;

FIG. 4 is a flow chart showing operation of a digital rights manager of the system and method of FIG. 1;

FIG. 5A is a flow chart of a first scenario showing lending of an electronic item by the system and method of FIG. 1;

FIG. 5B is a flow chart of a second scenario showing lending of an electronic item by the system and method of FIG. 1;

FIG. 5C is a flow chart of a third scenario showing lending of an electronic item by the system and method of FIG. 1;

FIG. 5D is a flow chart of a fourth scenario showing lending of an electronic item by the system and method of FIG. 1;

FIG. 6 is an architecture diagram of an embodiment of a system and method for lending an electronic item in accordance with an aspect of the present invention;

FIGS. 7A and 7B are entity relationship diagrams for database provided in the library server of FIG. 1;

FIG. 8 is a schematic illustration of the content management architecture of a system and method for lending an electronic item in accordance with an aspect of the present invention; and

FIG. 9 illustrates a page as displayed on a communications device of a system and method for lending an electronic item in accordance with an aspect of the present invention, used by a borrower to navigate the system.

### BEST MODE FOR CARRYING OUT THE INVENTION

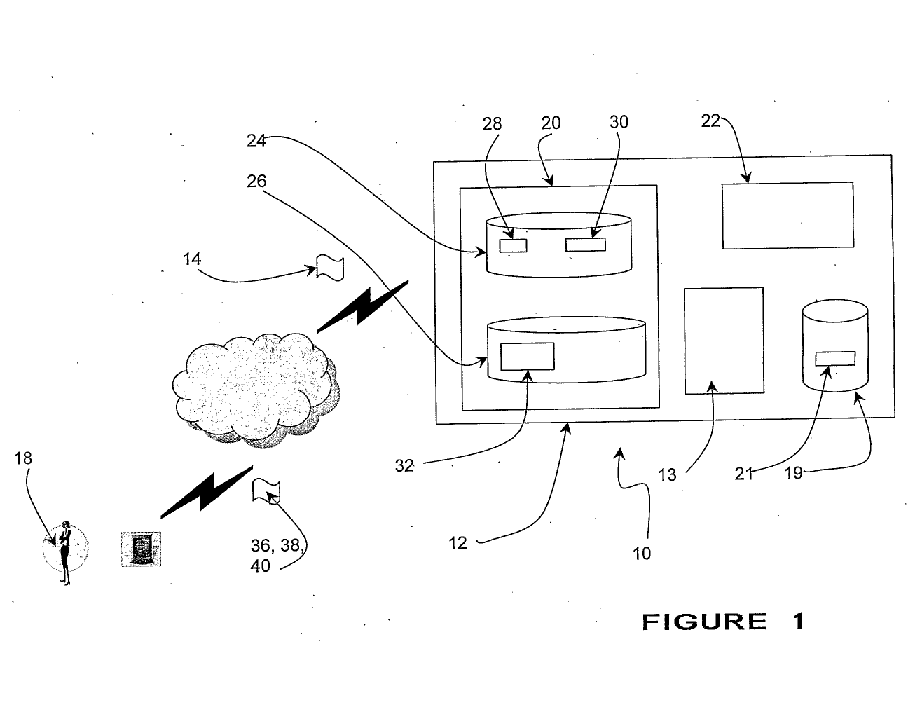

In FIG. 1, there is shown an embodiment of a lending system 10 for lending an electronic item in accordance with the present invention.

Typically, the lending system 10 described herein is provided by a service provider such as a library. Borrowers are registered members of the service, as will be described in more detail below.

The lending system 10 comprises a library server 12 to which a client in the form of a Personal Digital Assistant (“PDA”) 14 may be selectively connected via a communications network 16 to convey messages there-between.

Please note that the client is not limited to being a PDA, however, and may be any communications device capable of sending and receiving messages via a communications network, including a mobile phone or personal computer.

The PDA 14 is operated by a borrower 18, and is used to access and display econtent accessed at the library server 12. The borrower 18 is a member or subscriber to the service operating using the library server 12. This service provides access to econtent as will be described in more detail below.

The PDA 14 has a memory (not shown), adapted to store econtent items. Additionally, the PDA 14 has an operating system, not shown, for executing application software stored in the memory facilitating communication via the communications network 16 and accessing econtent items stored in the memory. Any suitable operating system can be used. Econtent is displayed on the PDA 14 using any suitable application such as Adobe™ Acrobat Reader to display the econtent as so-called PDF (“portable document format”) files or documents. The use of PDA's and other communications devices to access electronic files over the Internet or other communications networks is well known and need not be described in any further detail herein, except as is relevant to the present invention.

The PDA 14 is in data communication with the library server 12 via the communications network 16.

The library server 12 has a collection of econtent items stored in a memory 19 thereof for lending to borrowers 18, registered to borrow econtent items from the library server 12.

The econtent items in the memory 19 include books, journals, monographs, articles, chapters, documents, diaries, images, movies, and music stored, distributed and/or accessed in digital form.

Each econtent item in the memory 19 is permitted to be lent for a number of time periods that make up a predetermined total loan period. Each time period shall hereafter be referred to as a loan instance.

A loan instance is an arbitrary unit of lending, whose purpose is to limit the availability of an econtent item to members of the library server 12.

In the embodiment described, the provider of the service purchases each econtent item from an econtent aggregator (not shown) with 325 loan instances per annum included, with a loan instance defined as, “any period longer than 5 minutes and no longer than 24 hours during which a specific member is accessing the econtent item.” Each econtent item is stored in the memory 19 in a suitable database structure along with information regarding the number of loan instances—in this embodiment 325—that the econtent item can be accessed.

Each time a member so accesses the econtent item, one loan instance is used up for that econtent item.

In an alternative embodiment of the invention, each econtent item can be purchased by the service provider from an econtent aggregator with 200 loan instances per annum included, with a loan instance defined as, “any period of less than 24 hours during which a specific borrower has the econtent item downloaded and accessible on a personal computer, laptop or handheld device”.

Loan instances can be used up simultaneously by numerous borrowers who access or, in the case of downloaded econtent, have access to, the same econtent item.

When all of a particular econtent item's allocated loan instances are used up, the econtent item is unavailable to borrowers until either:
a) The service provider buys another copy of the econtent item for storage in the memory 19, or
b) the following year, when the number of available loan instances for the econtent item are restored to the original number, i.e. 325 in the embodiment described.

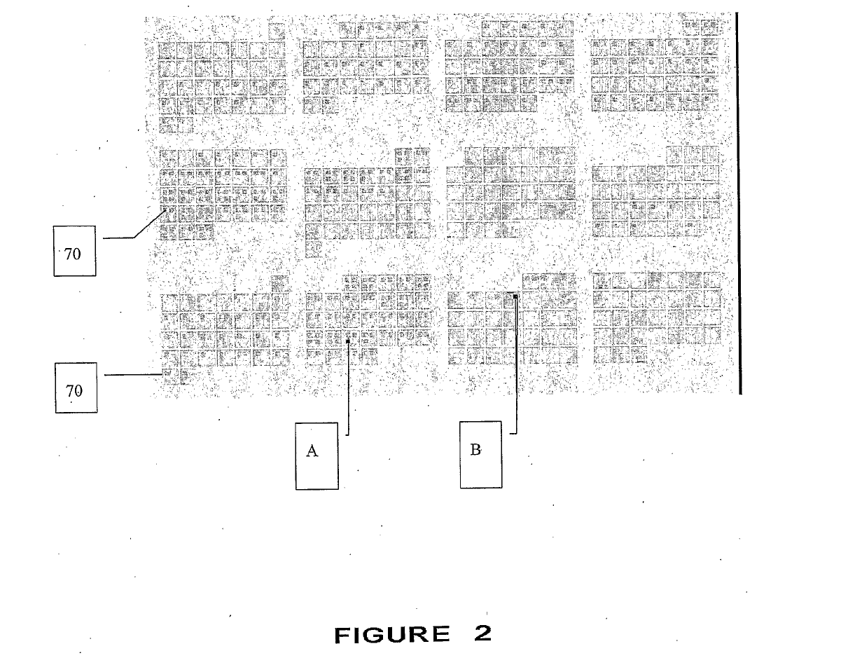

In FIG. 2 of the drawings, there is illustrated a calendar exemplifying how an econtent item's 21 allotment of loan instances may be used up over a year. Each mini square 70 represents a single loan instance. In FIG. 2, point A is a number of loan instances prior to the expiration of the total number of loan instances. At this point, the library server 12, is operable to send an automatic notification to the service provider indicating that there are so many loan instances remaining. At point B in FIG. 2, all 325 loan instances have been used. The econtent item 21 will still be available to preview to borrowers, but cannot be loaned. In order for the service provider to loan the econtent item 21, a further copy must be purchased, or made available through a short-term loan option, which is described further below. As can be seen from FIG. 2, the system 10 enables the service provider to better meet the peaks and troughs of demand for the econtent item 21. Multiple members can access the same econtent item simultaneously, or single users can access the econtent item on an event-by-event basis. Usage of the econtent item is limited to a total number of loan instances per year, whether those loans happen over a few busy days or are spread across the whole year.

Returning to FIG. 1 of the drawings, the library server 12 comprises a processor 13, a loan manager 20 and a digital rights manager 22.

The processor 13 processes messages received via the communications network 16 in a manner well known to persons skilled in the art.

The loan manager 20 manages lending of econtent items stored in the memory 19 to the borrowers 18, and includes a registration database 24 and an econtent item database 26.

The registration database 24 has a plurality of member records 28. Each member record 28 comprises a set of member information relating to a particular member of the library server 12, including:
name;
address;
date of birth;
borrowing rights;
unique registration identification number, or userID;
password for member authentication; and
details of econtent items presently borrowed by the member.

Each member record 28 is allocated to a particular member of the library server 12. One of the member records 28 is for the borrower 18, and hereafter shall be referred to as the borrower record 30. The borrower record 30 facilitates the lending of econtent items from the library server 12 to the borrower 18.

The registration of a person as a member of a library, and the allocation of a unique registration identification number, or userID, and corresponding password for authenticating the member's identity are well known to persons skilled in the art, and will not be described in further detail herein.

The econtent item database 26 has a plurality of econtent item records 32. Each econtent item record 32 comprises a set of econtent item information relating to a particular econtent item in the memory 19, including:
reference details;
number of loan instances remaining;
number of members currently loaned to; and
access permissions.

The digital rights manager 22 imposes digital rights settings on econtent items prior to access by a member of the library according to the borrowing rights of the member, to control the extent to which the member is able to digitally manipulate the econtent item, including copy/paste, amend, print, distribute and save.

The functions of the above components, and additional features of the lending system 10, will now be described with reference to the lending system 10 in use.

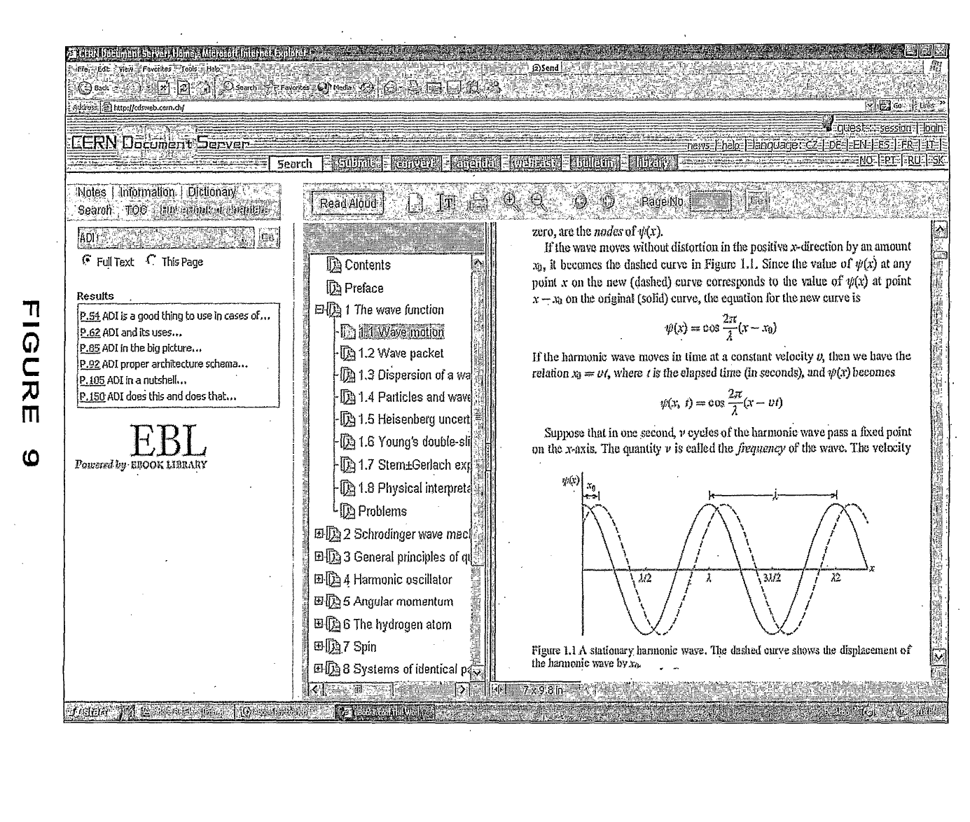

When a borrower 18 wishes to access an econtent item 21, the borrower 18 will access the library server 12 through a user interface such as a browser displayed on the PDA 14. The borrower is able to navigate through one or more pages, to browse for particular econtent items, and to log on to the service. The use of such browsers is well known to persons skilled in the art. FIG. 9 is an illustration of a page displayed on a PDA 14 and used to navigate the service provided by the library server 12.

To borrow a particular econtent item 21 from the memory 19, the borrower 18 sends a request communication message 34 to the library server 12 via the PDA 14.

The request communication message 34 is processed by the processor 13 and contains a set of request information. The set of request information includes:
the borrower's 18 unique registration identification number;
the borrower's 18 password;
a requested loan period; and
the reference details for the econtent item 21.

On receiving the request communication message 34 and the set of request information contained therein, the processor 13 authenticates that the borrower 18 is a member of the library server 12. This is done by comparing the set of request information with the corresponding information contained in the borrower record 30 of the registration database 24.

In the embodiment described, an Online Public Access Catalogue (“OPAC”) system (not shown) is used to authenticate the borrower 18. In an alternative embodiment of the invention, a proxy server is used to authenticate the borrower 18. Such authentication systems are well known to persons skilled in the art, and will not be described in further detail herein.

In some cases, the library server 12 may not be able to authenticate the borrower 18 and verify that the borrower 18 is a member of the library server 12. In such a situation, the library server 12 sends the borrower 18 a failure communication message 36 informing the borrower 18 that they have not been authenticated as a member of the library server 12 and prompting the borrower 18 to repeat the first communication message 34 or to become a member of the library server 12, as appropriate.

Once the borrower 18 has been successfully authenticated, the processor 13 determines if the borrower 18 has the right to access the requested econtent item 21. This is achieved by comparing the borrowing rights stated in the borrower record 30 with the access permissions for the econtent item 21 in the econtent item database 26.

If it is determined that the borrower 18 has the right to access the requested econtent item 21, the processor 13 and the loan manager 20 then determine whether the number of loan instances remaining for the econtent item 21 have been exceeded, or will be exceeded if the econtent item 21 is lent to the borrower 20 for the requested loan period. To do this, the loan manager 20 compares the requested loan period with the number of loan instances remaining for the econtent item 21 in the econtent item database 26.

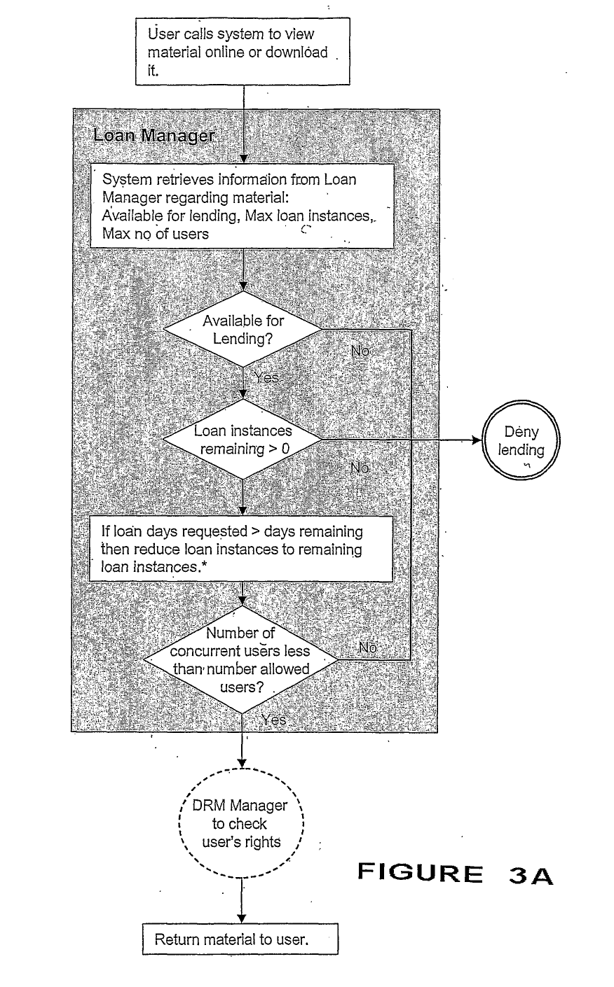

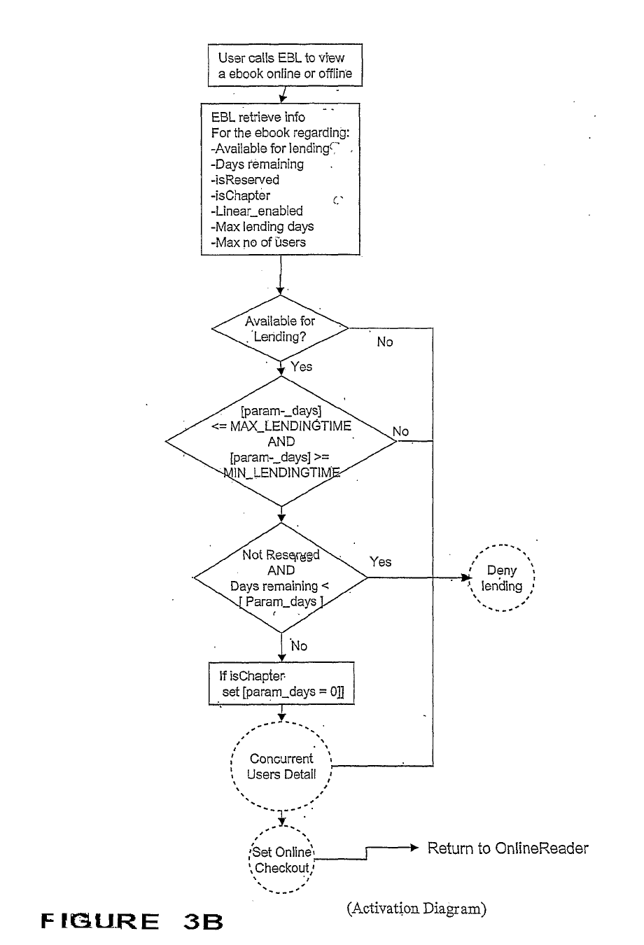

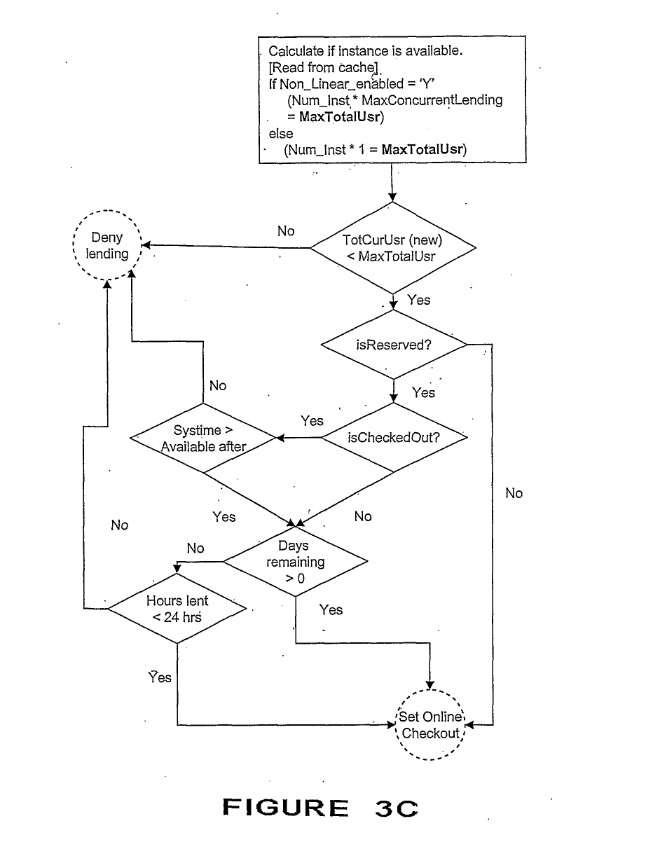

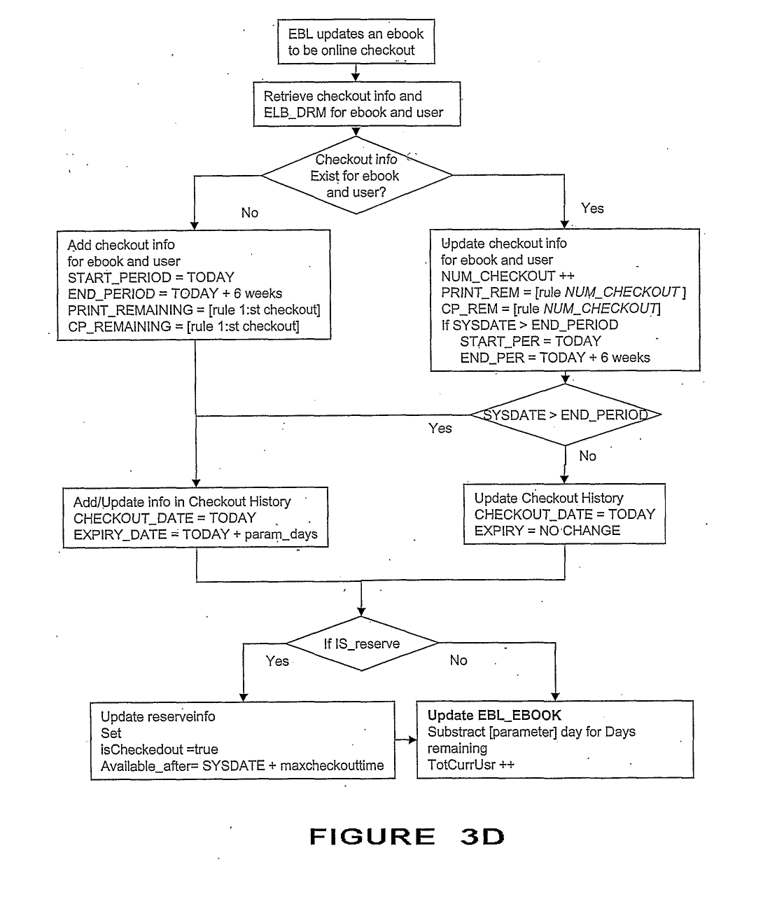

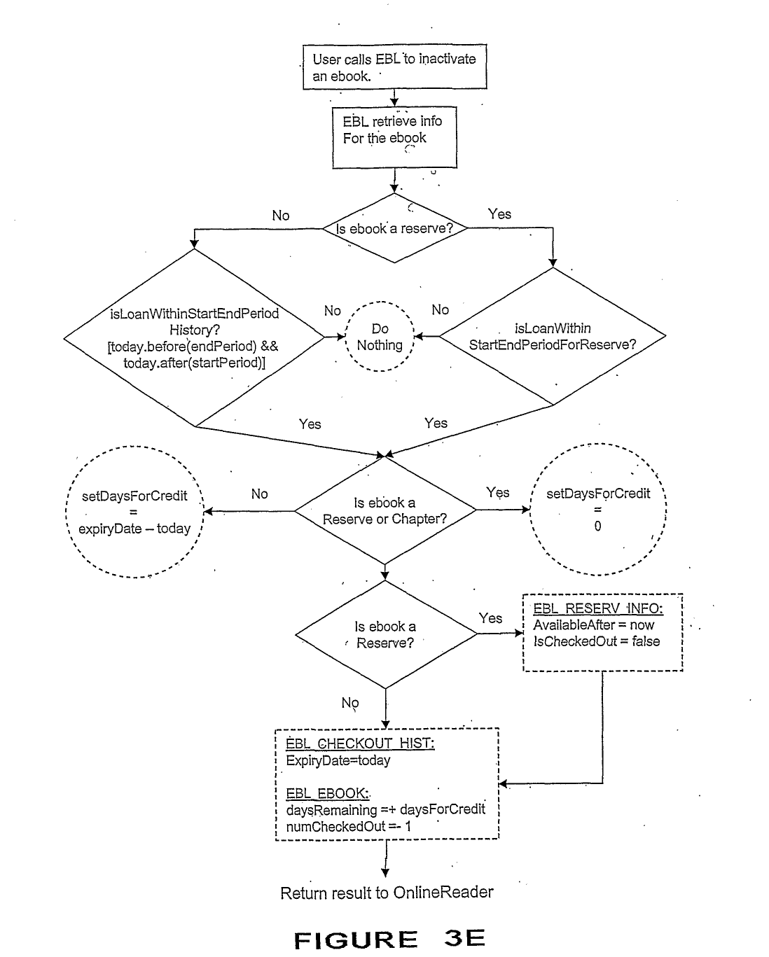

FIG. 3A to 3E of the drawings illustrate this process. In particular, FIG. 3A illustrates the general process:
The library server 12 retrieves all the relevant details for the econtent item 21, such as whether it is available, how many loan instances are available, and how many concurrent borrowers are allowed for the econtent item 21; and
The library server 12 checks all these parameters and allows or denies lending as appropriate.

FIG. 3B sets out the initial activation or check out sequence. FIG. 3C describes the validation process where there are concurrent lenders. FIG. 3D sets out the process that the library server 12 follows for updating lending details, and FIG. 3E sets out the process for checking in the econtent item 21 (“inactivation”) at the end of a loan.

If the number of loan instances remaining for the econtent item 21 have been exceeded, then the borrower 18 is denied access to the econtent item 21 and is informed of the same by a denial communication message 38 from the library server 12 sent to the PDA 14.

If the number of loan instances remaining for the econtent item 21 have not been exceeded or will be exceeded if the econtent item 21 is lent to the borrower 20 for the requested loan period, then the borrower 18 is allowed access to the econtent item 21 for the requested loan period, or until the number of loan instances is reduced to zero, as appropriate. This ensures that the econtent item 21 is not lent for more than the maximum number of loan instances allocated to it.

The extent of the borrower's 18 access to the econtent item 21 is determined by the digital rights manager 22. The digital rights manager 22 sets the extent to which the econtent item 21 may be printed, copied or pasted by the borrower 18 according to the borrowing rights of the borrower 18 and the number of times the econtent item 21 has been borrowed by the borrower 18 according to the borrower record 30. Additionally, the digital rights manager 22 sets the date that the borrower 18 will cease to have access to the econtent item 21.

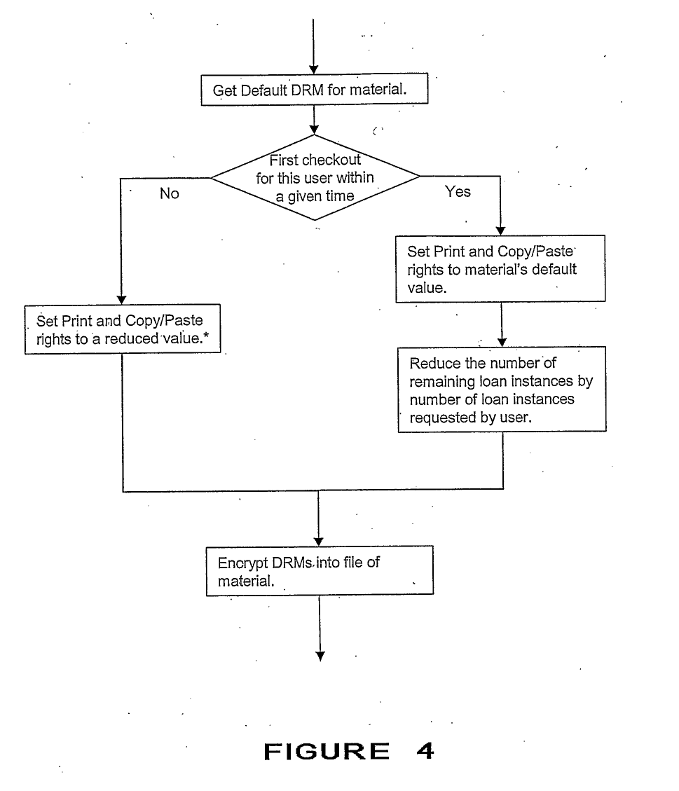

FIG. 4 illustrates the process of protection of the econtent item 21 by the digital rights manager (“DRM”) 22.

Subsequently, the library server 12 sends a confirmation communication message 40 to the borrower 18 informing the borrower 18 of the details of the econtent item 21, the duration of the loan period, and the borrower's 18 digital rights with respect to the econtent item 21, and containing the appropriately digitally protected econtent item 21.

The loan manager 20 and digital rights manager 22 then appropriately update the borrower record 30 of the registration database 24 and the record for the econtent item 21 in the econtent item database 26.

Additionally, for each loan of the econtent item 21, a history table (not shown) is maintained by the loans manager 20 to track usage of the econtent item 21. The digital rights manager 22 updates and maintains all digital rights related information for the econtent item 21 in the same history table.

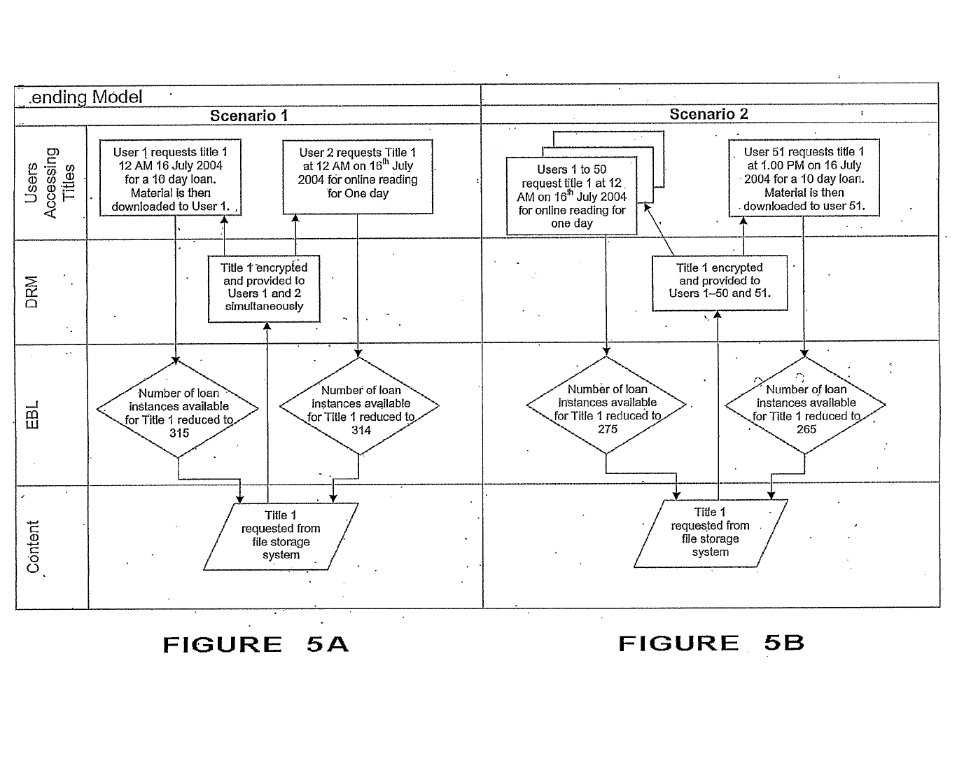

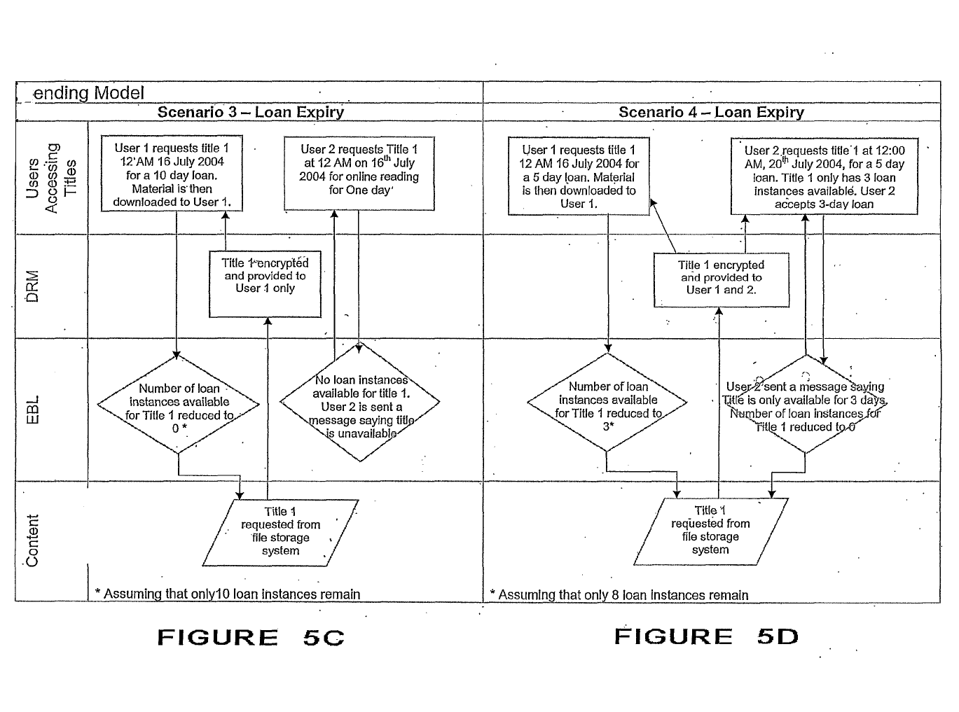

FIGS. 5A to 5D depict four sample scenarios where an econtent item is borrowed by one or multiple members, either simultaneously or in sequence. The scenarios show how the total number of remaining available loan instances for the econtent item 21 is affected by on-going use.

In scenario 1, a first borrower requests a Title 1 for a 10 day loan. At the same time, a second borrower requests Title 1 for one day of online reading. This makes a total of 11 loan instances. In this scenario, Title 1 has 325 loan instances available. Title 1 is made available to both borrowers and the number of loan instances for which the title is available is reduced to 314, and the econtent item database 26 updated accordingly.

In the second scenario, there are 50 simultaneous requests for title 1 for one day of online reading, which is allowed and Title 1 is downloaded to the 50 borrowers. This reduces the number of loan instances for Title 1 available to 275. An hour later another borrower requests Title 1 for 10 days. As there are 275 loan instances available, the loan is allowed, and Title 1 is downloaded to that borrower. The number of loan instances available for Title 1 is now reduced to 265.

In the third scenario, Title 1 only has 10 loan instances remaining. A first borrower requests Title 1 for 10 days, which is allowed and Title 1 is downloaded to the first borrower. However, when a second borrower requests the same title, because there are no loan instances remaining, the request is refused.

In the fourth scenario there are only 8 loan instances remaining. A first borrower requests Title 1 for a five day loan. This is allowed and the item is downloaded to the first borrower. A second borrower also requests a five day loan, but, because there now only three loan instances remaining, the borrower is only able to access the item for three days rather than five.

Accordingly, it can be seen that the system and method of the present invention provides the following advantages:
a) By allowing liberal, yet not unlimited, multiple concurrent use of an econtent item, the present invention enables librarians to better manage the shifts in demand for titles in their collection, without having to turn away patrons because their requested item is already “checked out” to another user;
b) The present invention merges the access benefits of a subscription-based acquisition model with the individual book selection process with which librarians are familiar. Because of the inbuilt usage limitations in the present invention, publishers are more willing to accept a once-off, up-front payment for an item, rather than requiring ongoing annual license fees; enabling distributors to sell individual items, rather than large databases, to organisations. Thus, for example, a librarian will be able to compile a collection of ebook titles that are relevant to their organisation's users, rather than having to settle for a single database of titles of mixed relevance; and
c) The present invention addresses librarians' concerns about preservation. Because librarians are able to pay a single up-front fee for each item without ongoing subscription fees, they can be confident that they will keep the collection of econtent that they have assembled, without the risk that, at some future point when they cannot afford subscription fees, their collection of econtent will vanish.

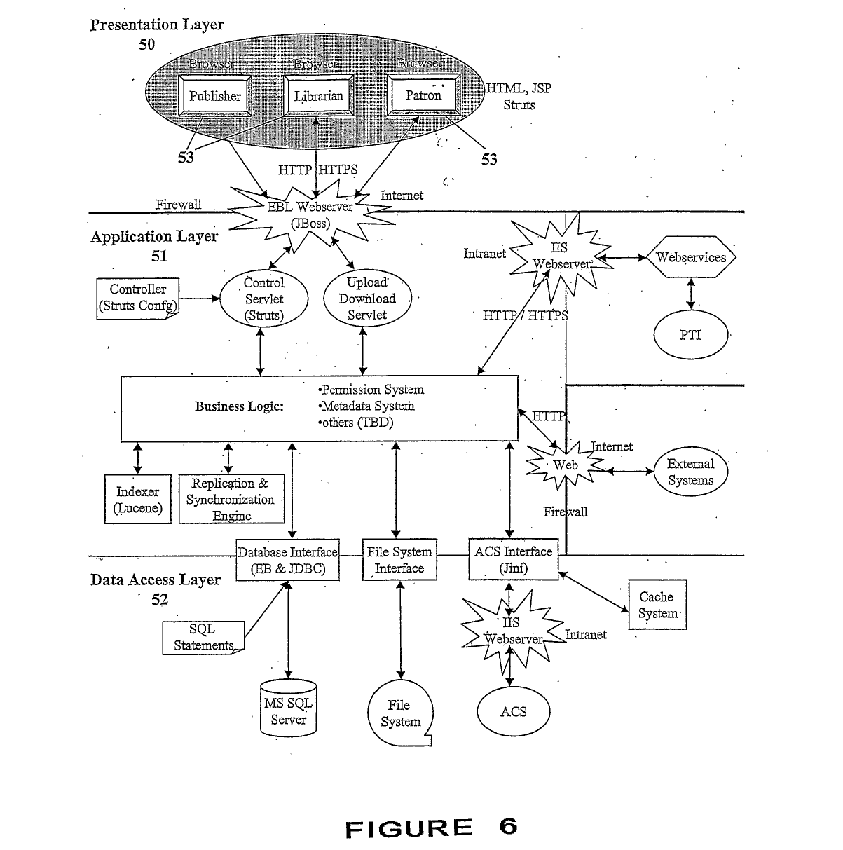

FIG. 6 of the drawings illustrates the system architecture of an embodiment of the present invention. The presentation layer 50 is concerned with how the system is presented to the user and how the software used by the borrower 18 (for example the browser and HTML) interacts with the library server 12. In FIG. 6, there are three types of user 53 illustrated. One is the borrower, but others can be the librarian, the publisher, and an administrator (not shown).

The application layer 51 is the main core of the system, and resides on the library server 12. The controller and control servlet links browsers with the functionality of the server 12. The upload/download servlet deals with the uploading and downloading of the econtent items as PDF files. The business logic deals with the main functionality of the server 12, for example dealing with permission management, lending rules and so on. The indexer provides the searching capability, allowing users to search through keywords and so on. The replication and synchronisation engine ensures that when data is modified that this changes are synchronised and replicated throughout the system.

The data access layer 52 “hides” the database and file specific information from the application layer 51. In this embodiment, the database uses Microsoft® SQL as the database, but any suitable database can be used.

The file system interface ensures that meta-data records are efficiently stored and retrieved by determining where these records are stored in the file system.

The ACS interface interfaces with the content management system—which in this embodiment is an Adobe Content Server (ACS) application. The ACS provides a number of functions:
Encrypting PDF documents;
Setting specific attributes such as expiry dates, number of pages that can be printed, etc.
The rules for lending and so on, are set within the application layer 51.

The cache system allows for caching of the most commonly used econtent items.

In addition to the components referred to above, the system may include other components such as PTI and external components.

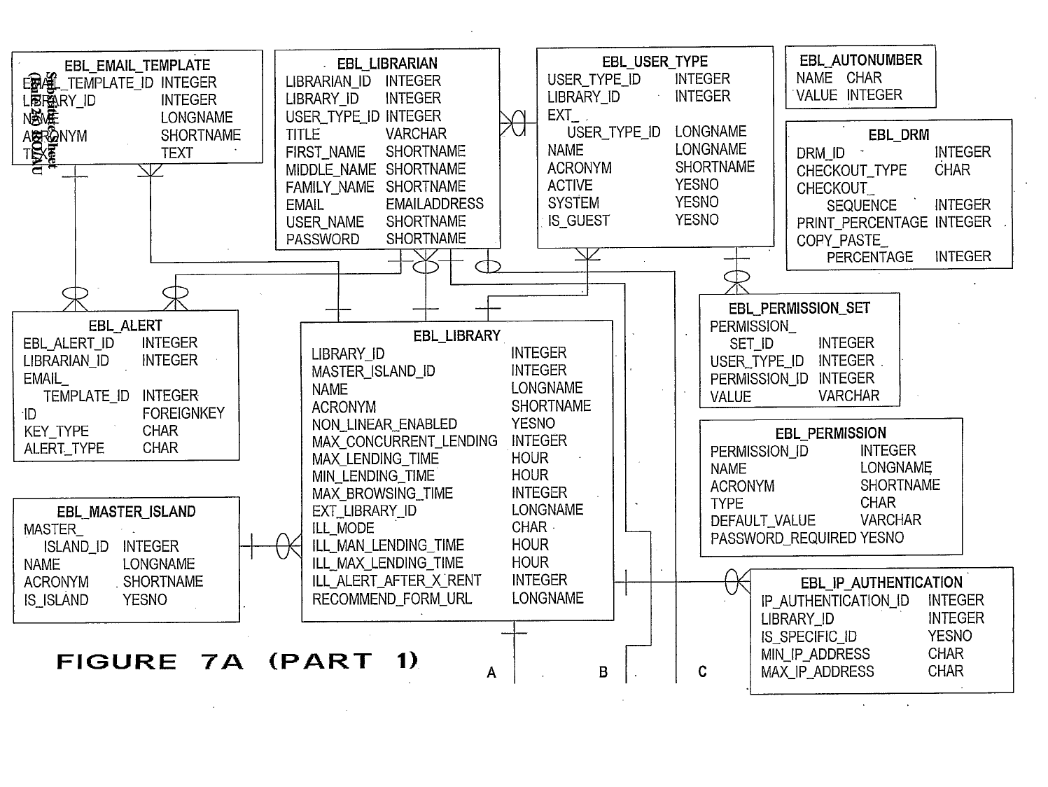

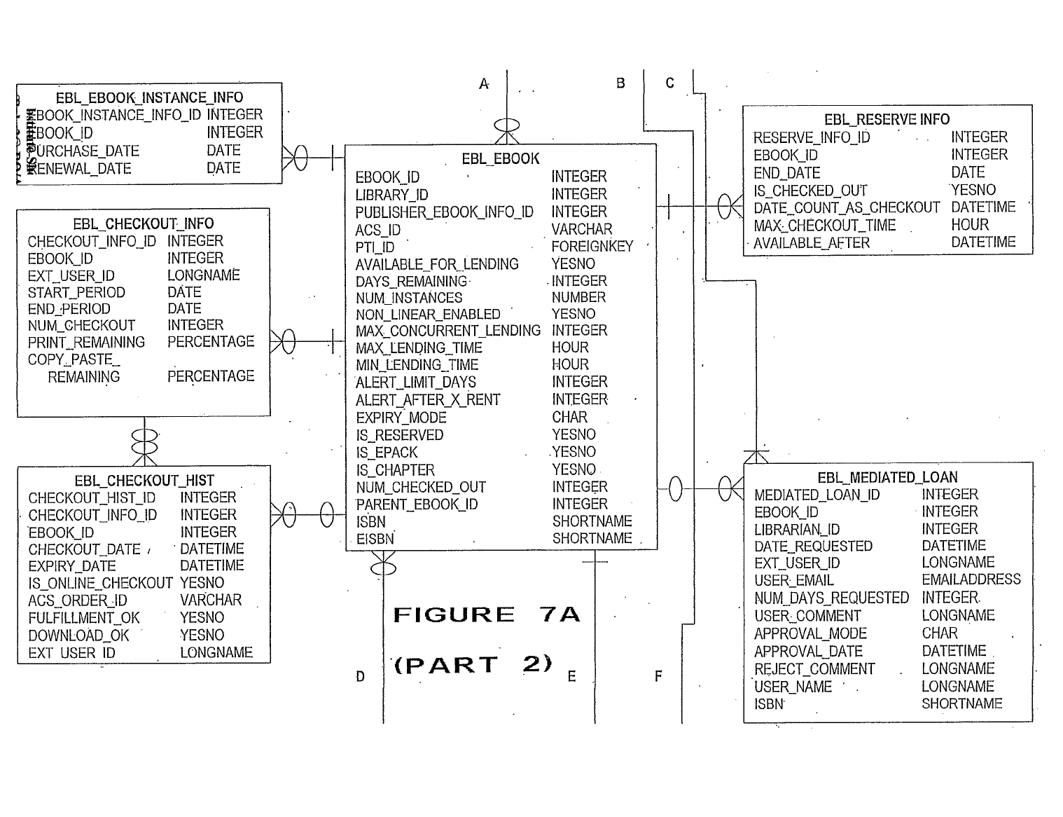

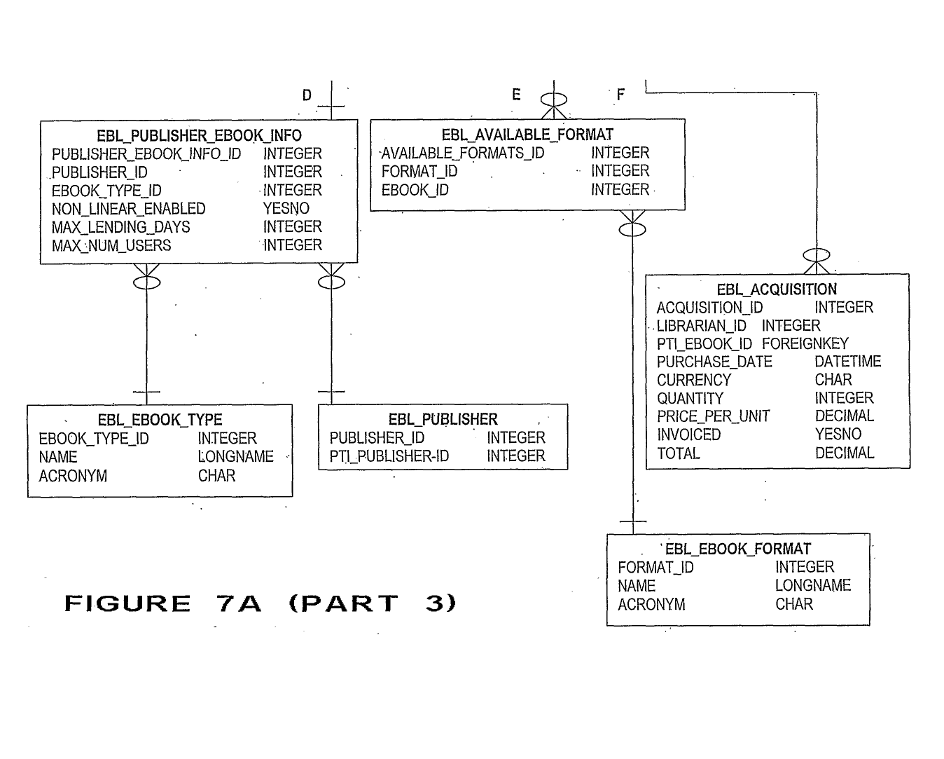

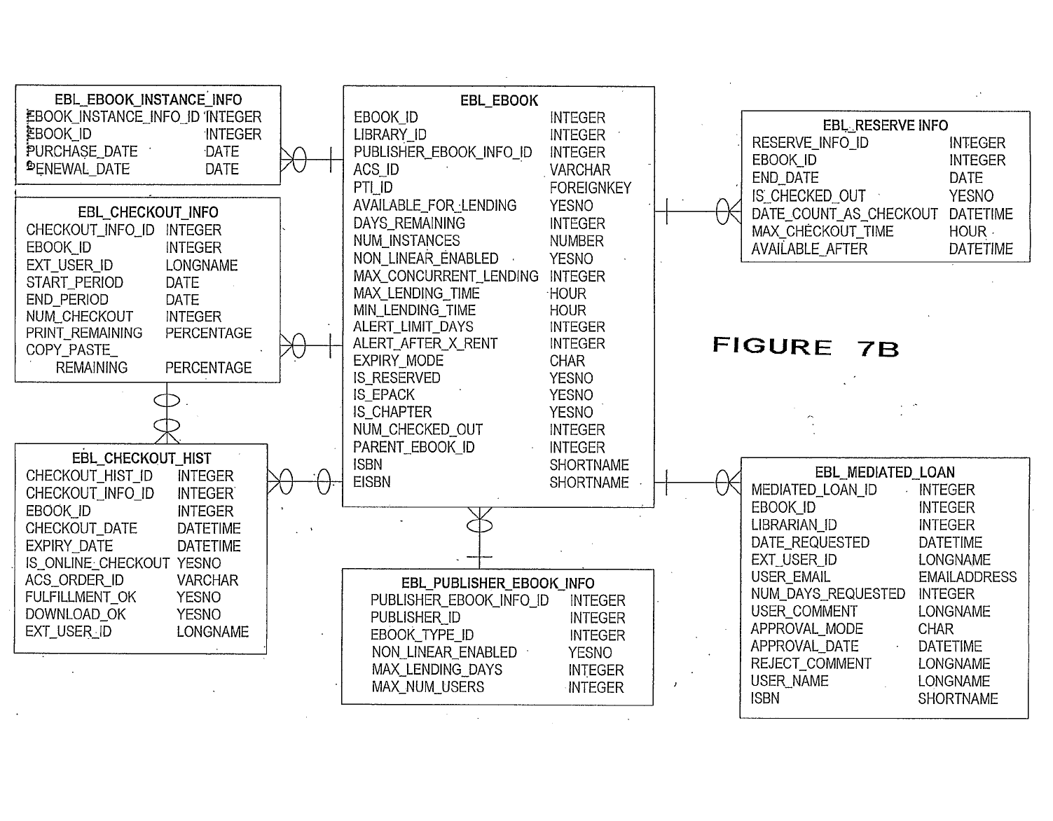

FIG. 7A is an entity relationship diagram showing the various entities stored in the databases, with their attributes and the relationships therebetween. FIG. 7B is an entity relationship diagram illustrating those entities involved in the loan management process.

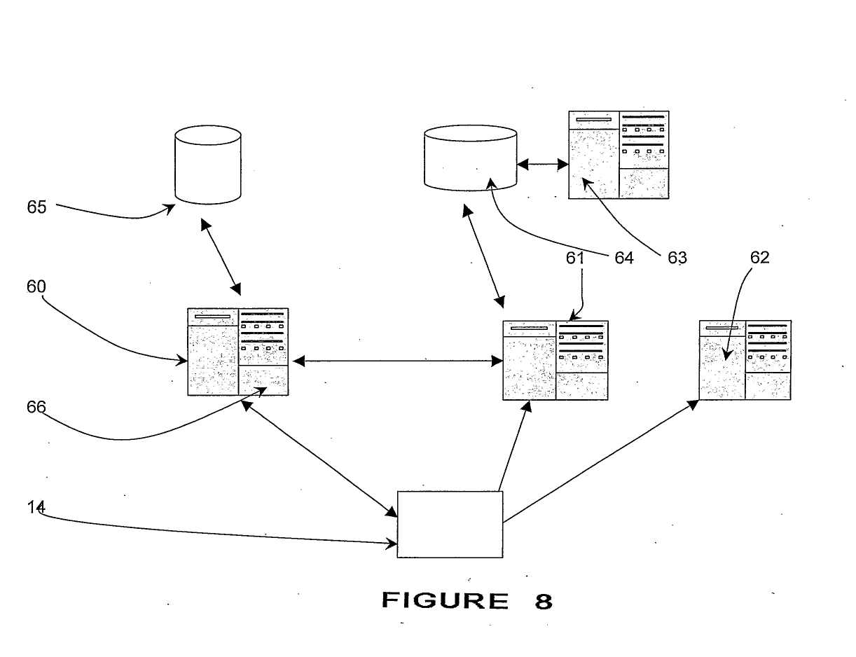

FIG. 8 illustrates how content management can be implemented in the system 10. In this embodiment, the lending system 10 includes a main server 60, a fulfilment server 61, and a download server 62, as well as a content management server 63. There is a content management database 64, and a main database 65. The system operates as follows:
1. The borrower 18 selects the econtent item 21 they wish to borrow by clicking on a link in the EBL Portal search results page 40 that is displayed on their PDA 14, and as described above.
2. The main server 60 receives the loan request and queries the main database 65 for the lending permissions for the econtent item 21 based on the users EBL_USER_TYPE. This includes the loan expiry date, and any additional digital rights management settings—such as number of pages that can be printed or selections copied etc. These settings are passed to a fulfilment module 66 provided within the main server 60.
3. The fulfilment module 66 generates a Fulfillment URL with the custom lending parameters and sends it to the fulfillment server 61 for verification and validation.
4. The fulfillment server 61 will query the content management database 64 to ensure that the loan request hasn't previously been filled and that the econtent item 21 is available for download.
5. If the loan request is validated successfully, the econtent item's 21 availability details will be returned to the fulfilment server 61 for processing and generating a protocol response document to the borrower 18.
6. The fulfillment server 61 generates the protocol response document which contains the econtent item's 21 download server location 62, and voucher location details that are required by the borrower's 18 econtent reader software, such as Adobe Acrobat Reader™, and sends it to the main server 60.
7. In response to receipt of the protocol response document, main server 60 forwards the protocol response document from the fulfillment module 66, back to borrower's 18 PDA 14. This is added into the reply to the borrower's 18 original loan request.
8. Once the borrower's 18 PDA 14 receives the response from the main server 60, the PDA browser will automatically load and start up the econtent reader application (eg. Adobe Acrobat reader™), passing in the protocol response document as a parameter. The econtent reader application then contacts the fulfillment server 61 with a request to download the voucher for the econtent item 21. At this point, a public key is sent to the fulfilment server 61 for the server to encrypt the data it will return.
9. In response to the request, the fulfillment server 61 requests the packaged econtent item's 21 voucher from the content management database 64.
10. The voucher is returned to the fulfilment server 61 from the content management database 64, and re-encrypted with the public key sent from the borrower's 18 econtent reader application. This voucher contains the shared private symmetrical key that unlocks the encrypted econtent item 21.
11. The encrypted voucher is returned from the fulfilment server 61 to the PDA 14. The econtent reader application will then store the voucher ready for decrypting the econtent item 21 once downloaded.
12. The econtent reader application looks up the download server's URL in the protocol response document, and requests the econtent item 21 from it.
13. In response to the request, the download server 62 returns the encrypted econtent item 21 to the requesting reader, where it is stored in its encrypted state on the PDA's memory. The econtent reader application will then load and decrypt the book's voucher in memory, extracting the private key to decrypt the econtent item 21, for display to the borrower 18. This process is done on a page by page basis.

Econtent items stored in the lending system memory 19, may be purchased from a number of suppliers—typically from an online ordering arrangement from the aggregator, or from other suppliers such as publishers or online retailers.

In the embodiments described herein, there are the following copyright restrictions
With the purchase of an econtent item at library retail price, the purchasing institution is entitled to 325 days lending permission for that econtent item per year (note: days of lending permission are not transferable between econtent items and unused lending days do not roll over year to year.)
The number days of circulation will be tracked by the library server 12 based on length of loan assigned to the econtent item at checkout (For example, if a borrower 18 checks out an econtent item with a loan period set at 1 week but deletes the book at 6 days, this loan instance subtracts 6 days from the total days of lending for that econtent item.)
The 325 days of lending permission per econtent item 21 renews every year.

Libraries can manage the lending permissions for purchased econtent items in the following ways:
Length of loan—(a minimum of 1 day lending period applies for all econtent items in general circulation).
A library can restrict the number of concurrent users per title.
Libraries can set alert at a pre-determined point in annual lending usage.
Libraries can set automatic purchase or rental of econtent items once annual lending permissions have been used.

Multiple Concurrent Access:

Within the embodiment described herein, it is possible to make econtent items available to libraries under three lending terms. They can be made available under a combination of these models with pricing set separately for the different access terms.

The main lending model is non-linear lending. This model is intended to be the default model for all monograph econtent items.

Textbook lending is meant for econtent items which are published as instructional material.

The reference lending model is intended for reference titles which require a greater amount of access than a traditional monograph.

It is possible to set an econtent item as both a monograph and also set different terms for reference access. For example, a publisher may decide to offer a title with non-linear access for 100% list price and also offer unlimited access at 150% of list price. The library at the point of purchase would decide which access would suit.

Monograph/Non-Linear Lending™:

In this model, econtent items are not restricted to a linear distribution model and can be lent to any number of users at the same time with the combined lending time in total not to exceed 325 days.

Textbook:

In this model, econtent items which are considered as textbook material by publishers can be limited to a maximum of 5 concurrent users. It is also recommended that publishers price textbook titles in accordance with this usage model to establish fair compensation for this level of use.

Reference/Unlimited Access:

The reference lending model is for titles which are to be made available on an unlimited access basis. The access to these titles will be unrestricted to authenticated users from a purchasing library. The pricing for this type of access will be determined by the publisher.

Length of Loan:

The service provider (i.e the library) may determine the loan length across an entire collection and/or on a title by title basis. Econtent items in general circulation will have a minimum loan period of 1 day and a maximum loan period of one year. The length of the loan can also be determined by the method of lending.

Online Browsing:
Unlimited for 10 minutes at a time
Browsing does not allow any print or copy functionality
In this case, the system will monitor browsing in a 24 hour period so that a user may not access a particular econtent item multiple times without enacting a loan.

Online Lending:
Econtent items may be checked out online (1 day minimum past 10 minutes browsing).
Online browsing will be enabled in a proprietary PDF-based encrypted browser.

In this case, the system will monitor usage per user so that a library will not be ‘charged’ more than one day loan for the same user access the same econtent item within a 24 hour period.

Offline Lending:
Econtent items may be checked out and downloaded to a members 18 computer or PDA 14.
Circulation period for checkout set by the service provider (1 day minimum).
Member 18 either checks econtent item in or the econtent item expires.

HTML Preview:
Members 18 will be able to browse a selection of the econtent items on an HTML preview page. This will include:
   Front Cover;
   TOC;
   Introduction; and
   Index.

The permissions of each loan will include a number of variables:

Downloads Per Loan Instance:

An econtent item may be downloaded once per offline loan instance. Once downloaded, the borrower 18 can utilise a passport sign in to transfer the econtent item to up to two authenticated devices within the allotted time loan period. This is to accommodate transferring the econtent item between laptop computer and/or desktop computer and/or PDA 14.

Printing:

Printing will be restricted to up to 20% of the total pages of the econtent item. The system 10 will track loan instances and printing. In the case of usage within the online reader, the library server 12 will monitor usage per user per title for a specified period (for example 6 weeks) and will reduce printing according to actual printing usage. In the case of offline access, the printing will be reduced to half on a second loan within a 6 week period and disallowed on subsequent accesses.

Copy & Paste:

Copy/Paste will be restricted to up to 5% of the total pages of the econtent item per loan instance. The copy/paste usage will be monitored as stated above for printing.

Noting/Highlighting:

Borrowers may make unlimited notes and may highlight unlimited selections of the econtent item per loan instance.

Read Aloud:

Read aloud functionality will be allowed for offline loans for all titles.

Once authenticated into the library server 12, a borrower 18 may browse econtent items for a limited time per title. No printing, copying or pasting is permitted within the online browser. The online browser is limited to a one day view.

The system also provides for reserve lending.

Reserve lending is only for online access and will not include an offline lending option.

Up to 1 chapter of an econtent item 21 may be placed in reserve circulation as another holding. Only 1 chapter of any selection from the same econtent item may be in e-reserve at any one time if the complete econtent item is to remain in general circulation as well.

Lending of these chapters is reserved to one user at a time with a maximum lending period of 1 day.

If a library wishes to create two or more separate reserve holdings whose combined content is more than 1 chapter from any one econtent item 21, then either the econtent item 21 is removed from general circulation until such time as the chapters are either removed from e-reserve or reduced to a maximum of one chapter or the library must purchase the additional chapters for reserve use.

Libraries may create a pack of chapters. This is a collection of chapters from various econtent items and may include chapters from any number of econtent items stored in the memory 19. A limit of one chapter may be included from any one econtent item holding in a pack. A library may also pay for additional chapters to be used in a pack for titles held in their catalogue.

These packs can be lent only as a reserve item which is restricted to no more than one user at a time.

The above permissions apply per holding per title. If a library has 2 copies of the same title, then they have the above e-reserve permissions for each title. For example, two holdings of an econtant item gives a library the right to use 1 chapter from each book or 2 chapters from that econtent item, without removing the econtent item from general circulation.

In order to ensure access to econtent item purchases beyond the service provider's subscription to the lending system 10, a copy of each econtent item title purchased by a service provider will be provided by download to a secure server. Permissions for these econtent items will be the same as those for an econtent item purchased through a regular retail sale.
Libraries will be permitted to print one copy of each book that is purchased in their collection (note: this copy will be marked with a watermark and/or statement that the copy is only allowed for archival purposes and may not be reproduced)
Libraries will have perpetual access to one copy of purchased econtent items beyond their subscription.

The system will also provide for short-term rental of econtent items that it doesn't have stored in memory 19. The econtent item is provided to the library on a temporary basis for lending to a borrower for a predetermined period. The econtent item will not be available to a service provider (or borrower) at the end of that predetermined period.

Modifications and variations such as would be apparent to a skilled addressee are deemed to be within the scope of the present invention.

1. A lending system for lending an electronic item from a host server to a client, the electronic item permitted to be lent for a predetermined total loan period; the lending system comprising:
a host server to which a client may be selectively connected via a communications network to convey messages there-between;
the host server having a storage device for storing the electronic item;
the host server having a loan manager for recording the period the electronic item has already been loaned; and
the host server having a processor to process messages received via the communications network;
wherein upon receipt of a request message from the client via the communications network, where the request message comprises an identifier for the electronic item and a requested loan period, the processor is operable to: determine a cumulative loan period comprising the total of the requested loan period and the period that the electronic item has already been loaned; compare the cumulative loan period with the total loan period; and, if the cumulative loan period does not exceed the predetermined total loan period, make the electronic item available to the client for the requested loan period.

2. A lending system according to claim 1, wherein the processor is operable, if the cumulative loan period exceeds the total loan period, to make the electronic item available to the client for period equal to the requested loan period minus the period that the cumulative loan period exceeds the total loan period.

3. A lending system according to claim 1, wherein the total loan period is valid for a predetermined length of time.

4. A lending system according to claim 3, wherein the predetermined length of time is one year.

5. A lending system according to claim 1, wherein the client has a unique identifier to uniquely identify the client to the host server, and the request message further comprises the unique identifier and the processor further processes the unique identifier to authenticate the identity of the client.

6. A lending system according to claim 1, further comprising a digital rights manager for controlling the extent to which the electronic item is protected.

7. A lending system according to claim 1, wherein each loan period comprises a predetermined number of loan instances.

8. A lending system as claimed in claim 7, wherein the loan instance is any period greater than five minutes and less than 24 hours.

9. A lending method for lending an electronic item from a host server to a client, the electronic item permitted to be lent for a predetermined total loan period; the lending method comprising:
recording the period the electronic item has already been lent;
receiving a request message from the client via a communications network, the request message comprising an identifier for the electronic item and a requested loan period;
determining a cumulative loan period comprising the total of the requested loan period and the period the item has already been lent; and
if the cumulative loan period does not exceed the predetermined total loan period, making the electronic item available to the client for the requested loan period.

10. A lending method according to claim 9, wherein, if the cumulative loan period exceeds the total loan period, the electronic item is made available to the client for period equal to the requested loan period minus the period that the cumulative loan period exceeds the total loan period.

11. A lending method according to claim 9, wherein the total loan period is valid for a predetermined length of time.

12. A lending method according to claim 11, wherein the predetermined length of time is one year.

13. A lending method according to claim 9, comprising:
allocating a unique identifier to uniquely identify the client to the host server, and the request message further comprises the unique identifier; and
authenticating the identity of the client using the unique identifier.

14. A lending method according to claim 9, comprising controlling the extent to which the electronic item is protected.

15. A lending method according to claim 9, wherein each loan period comprises a predetermined number of loan instances.

16. A lending method according to claim 15, wherein the loan instance is any period greater than five minutes and less than 24 hours.

17. A host server for use in a lending system for lending an electronic item, the electronic item permitted to be lent for a predetermined total loan period, the host server being arranged to be selectively coupled to a client via a communications network to convey messages there-between, the host server comprising:
a storage device for storing the electronic item;
a loan manager for recording the period the electronic item has been already been loaned; and
a processor operable to process messages received via the communications network;
wherein upon receipt of a request message from the client via the communications network, where the request message comprises an identifier for the electronic item and a requested loan period, the processor is further operable to: determine a cumulative loan period comprising the total of the requested loan period and the period that the electronic item has already been loaned; compare the cumulative loan period with the total loan period, and, if the cumulative loan period does not exceed the predetermined total loan period; make the electronic item available to the client for the requested loan period.

18. A host server according to claim 17, wherein the processor is operable, if the cumulative loan period exceeds the total loan period, to make the electronic item available to the client for period equal to the requested loan period minus the period that the cumulative loan period exceeds the total loan period.

19. A host server according to claim 17, wherein the total loan period is valid for a predetermined length of time.

20. A host server according to claim 19, wherein the predetermined length of time is one year.

21. A host server according to claim 17, wherein the client has a unique identifier to uniquely identify the client to the host server, and the request message further comprises the unique identifier and the processor is further operable to process the unique identifier to authenticate the identity of the client.

22. A host server according to claim 17, further comprising a digital rights manager for controlling the extent to which the electronic item is protected.

23. A host server according to claim 17, wherein each loan period comprises a predetermined number of loan instances.

24. A host server according to claim 23, wherein the loan instance is any period greater than five minutes and less than 24 hours.

25. A lending system for lending an electronic item from a host server to a client, the electronic item permitted to be lent for a predetermined total loan period; the lending system comprising:
a host server to which a client may be selectively connected via a communications network to convey messages there-between;
the host server having storage means for storing the electronic item;
the host server having loan managing means for recording the period the electronic item has already been loaned; and
the host server having processing means to process messages received via the communications network;
wherein upon receipt of a request message from the client via the communications network, where the request message comprises an identifier for the electronic item and a requested loan period, the processing means is operable to: determine a cumulative loan period comprising the total of the requested loan period and the period that the electronic item has already been loaned; compare the cumulative loan period with the total loan period; and, if the cumulative loan period does not exceed the predetermined total loan period, make the electronic item available to the client for the requested loan period.

26. (canceled)

27. (canceled)
